(19) United States
(12) Patent Application Publication
(10) Pub. No.: US 2005/0007327 A1
(43) Pub. Date: Jan. 13, 2005

(54) Color image display apparatus

(76) Inventors: Cliff Elion, Chats Worth, CA (US); Milan J. Seda, Missouri City, TX (US); Morris Betty, Redondo Beach, CA (US); Robert Tucker, Torrance, CA (US)

Correspondence Address: IRELL & MANELLA LLP, 840 NEWPORT CENTER DRIVE, SUITE 400, NEWPORT BEACH, CA, 92660, US

(21) Appl. No.: 10/406,969

(22) Filed: Apr. 3, 2003

Related U.S. Application Data
(60) Provisional application No. 60/374,327, filed on Apr. 22, 2002.

(51) Int. Cl. G09G 3/36

(52) U.S. Cl. 345/88

(57) ABSTRACT

An image display apparatus that includes a color filter coupled to a liquid crystal display. The color filter contains a two dimensional array of colored dots. The array may include discrete red, green and blue dots. To generate an image a controller selects a pixel address of the color filter from a matrix defined by a plurality of pixel points. The controller then selects one or more dots to be associated with the selected pixel address. With such a scheme the same dot may be associated with one or more pixels. Sharing dots reduces the number of red, green and blue dots required for a given screen size. This allows the LCD to be constructed with larger dots, thereby reducing the cost of producing the apparatus.

### REFERENCE TO CROSS RELATED APPLICATION

This application claims priority under 35 U.S.C §119(e) to provisional Application No. 60/374,327 filed on Apr. 22, 2002.

### BACKGROUND OF THE INVENTION

1. Field of the Invention

The subject matter disclosed generally relates to a color image display device.

2. Background Information

There are various types of image generating devices including cathode ray tubes (CRTs) and liquid crystal displays (LCDs). Liquid crystal displays include chemical crystals captured between two glass substrates. The opacity of the crystals can change in response to an electric field. LCDs are constructed so that the crystals are transparent in the absence of an electric field and become opaque in the presence of an electric field or vice versa. Electrodes and corresponding routing lines are formed on the glass in a manner to create individual image dots. Light is directed through the crystal, either from a backlight or the ambient. A crystal driven to an opaque state will absorb the light traveling through the LCD. A crystal in a transparent state will allow the light to travel through the LCD. A microcontroller may select certain dots to be either transparent or opaque to create a desired image.

Color LCDs typically have a color filter located between the glass substrates. The color filter may have a pattern of discrete red, green and blue filter dots to produce red, green and blue light, respectively. Images are typically defined in terms of discrete elements commonly known as pixels. Each pixel of a color LCD consists of a predetermined pattern of a red dot, a green dot and a separate blue dot for a total of three dots per pixel. Each pixel pattern of three dots defines an addressable point of an image. Color images can be generated by addressing each pixel and then selecting one or more dots within the pixel.

It is generally desirable to optimize the resolution of an image generating device. For a given screen size an increase in resolution typically requires a reduction in the size of the dot. Color LCDs include conductive filters that are relatively expensive to produce. Reducing the size of the dots and the internal conductive filters for a color LCD can increase the cost of the device. It would be desirable to reduce the cost of a color LCD while providing a commercially viable screen quality.

### BRIEF SUMMARY OF THE INVENTION

An image display apparatus that includes a color filter coupled to a liquid crystal display. The liquid crystal display and color filter create a plurality of colored dots. The apparatus may also include a controller that receives a pixel address. The pixel address corresponds to a pixel point located within a matrix of pixel points associated with the colored dots. The controller may select one of a plurality of dot patterns to correspond to the pixel address and then select one or more colored dots within the selected dot pattern.

### BRIEF DESCRIPTION OF THE DRAWINGS

FIG. 1 is an illustration of an image display apparatus;

FIG. 2 is an electrical schematic of the image display apparatus;

FIG. 3 is a cross-sectional exploded view of a screen of the image display apparatus;

FIG. 4 is an illustration of an embodiment of a color filter of the image display apparatus;

FIGS. 5a-b are enlarged illustrations showing a pixel point matrix superimposed onto a two-dimensional array of dots of the color filter;

FIGS. 6a-c are illustrations showing different pixel types;

FIG. 7 is a flowchart showing the generation of an image on the image display apparatus;

FIG. 8 is a cross-sectional exploded view of an alternate embodiment of the screen;

FIG. 9 is a cross-sectional exploded view of an alternate embodiment of the screen;

FIG. 10 is a cross-sectional exploded view of an alternate embodiment of the screen;

FIG. 11 is a cross-sectional exploded view of an alternate embodiment of the screen;

FIG. 12 is a cross-sectional exploded view of an alternate embodiment of the screen;

FIG. 13 is a cross-sectional exploded view of an alternate embodiment of the screen.

### DETAILED DESCRIPTION

Disclosed is an image display apparatus that includes a color filter coupled to a liquid crystal display. The color filter contains a two dimensional array of colored dots. The array may include discrete red, green and blue dots. To generate an image a controller selects a pixel address of the color filter from a matrix defined by a plurality of pixel points. The controller then selects one or more dots to be associated with the selected pixel address. With such a scheme the same dot may be associated with one or more pixels. Sharing dots reduces the number of red, green and blue dots required for a given screen size. This allows the LCD to be constructed with larger dots, thereby reducing the cost of producing the apparatus.

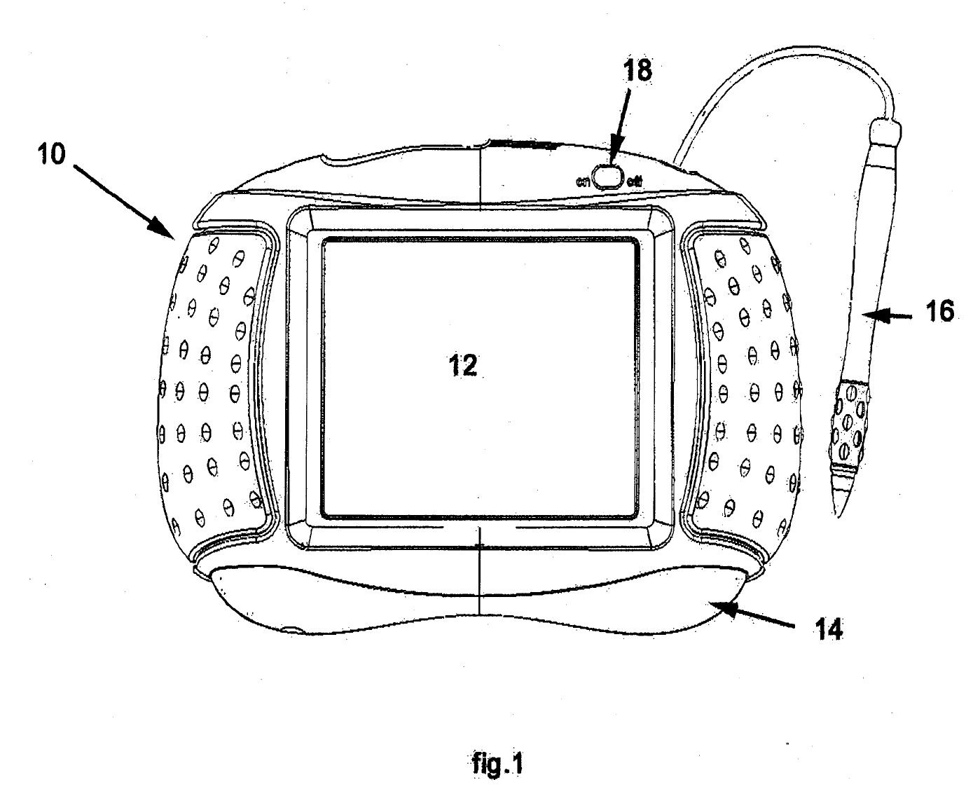

Referring to the drawings more particularly by reference numbers, FIG. 1 shows an embodiment of an image display apparatus 10. The image display apparatus 10 may include a screen 12 that is mounted to a housing 14. The apparatus 10 may include a touch pen 16 that can be placed onto the screen 12. The apparatus 10 may include a power on/off switch 18 attached to the housing 14.

The apparatus 10 may be similar to a toy touch pad produced by Fisher-Price, Inc. The toy touch pad may allow a user to draw images on the screen 12 with the touch pen 16. Although a toy touch pad is shown and described, it is to be understood that the image display apparatus may be any type of device that displays images.

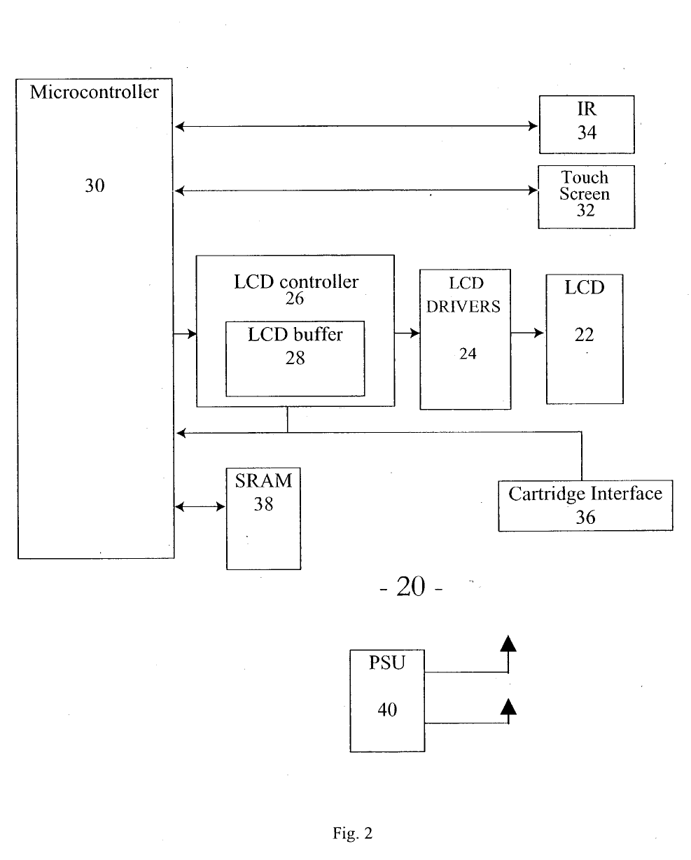

FIG. 2 shows an embodiment of an electrical system 20 of the apparatus 10. The system 20 may include a liquid crystal display (LCD) 22 that is coupled to LCD drivers 24. The LCD 22 is typically constructed to contain a plurality of discrete dots arranged in a two dimensional array. The LCD drivers 24 can drive the individual dots of the LCD 22.

The LCD drivers 24 are connected to a LCD controller 26. The LCD controller 26 selects the different drivers 24 to create an image on the LCD 22. The LCD controller 26 may include buffer memory 28.

The LCD controller 26 can be connected to a microcontroller 30. The microcontroller 30 can be connected to a touch screen sensor(s) 32 and a wireless input/output (I/O) port 34. The I/O port 34 may be an infrared (IR) receiver or transceiver. The microcontroller 30 may also be connected to a cartridge interface 36 and memory 38. The cartridge interface 36 may receive cartridges that include software routines. All of the devices 22, 24, 26, 28, 30, 32, 34, 36 and 38 may be powered by a power supply 40.

The microcontroller 30 may perform various computations in accordance with software/firmware routines. The software routines may be stored in memory 38 or provided through the cartridge interface 36. The microcontroller 30 may provide instructions to the LCD controller 26 to generate an image(s) on the LCD 22. The LCD controller 26 may perform various computations in accordance with software/firmware routines.

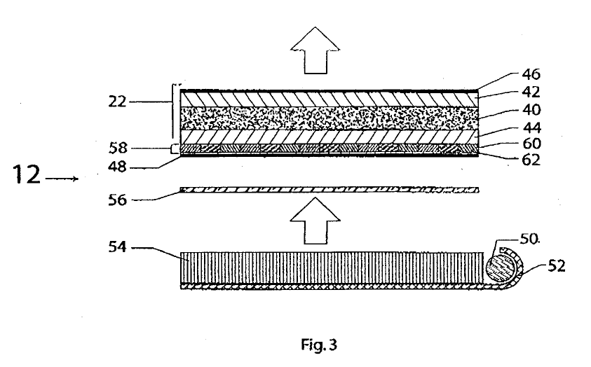

FIG. 3 shows an embodiment of a screen 12 of the image display apparatus 10. The screen 12 may include an LCD 22 defined by liquid crystal material 40 located between a front substrate 42 and a rear substrate 44. The LCD 22 may be a gray scale or non-gray scale type of device. The screen 12 may further include front 46 and rear 48 polarizers.

The apparatus 10 may include a backlight 50 that emits light. The light may be directed to the LCD 22 by a reflector 52, light guide 54 and a diffuser 56. By way of example, the backlight 50 may be a CCFL, LED, EL or incandescent light source. A color filter 58 may be attached to the rear substrate 44 of the LCD. The color filter 58 can be constructed by attaching a color media 60 to a filter substrate 62. By way of example, the color media 60 may be a film that is attached to the substrate 62, or applied to the substrate 62, such as by a screening method. Locating the color filter 58 external to the LCD 22 reduces the cost of producing the screen 12.

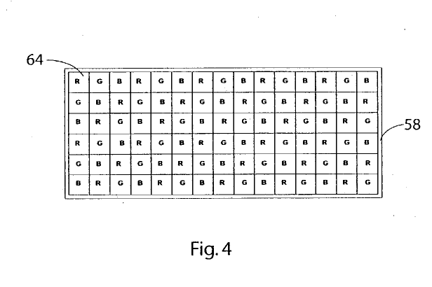

FIG. 4 shows an embodiment of the color filter 58. The filter 58 may include a two dimensional array of dots 64 arranged into rows and columns. The color dots 64 are aligned with corresponding dots of the LCD 22 so that colors can be discretely generated through the filter 58. Each dot 64 may include a predetermined color. By way of example, the dots 64 may include the primary colors of red R, green G and blue B.

The R, G and B dots are arranged so that each dot has immediately adjacent dots of a different color. For example, each red dot has an immediately adjacent green dot and an immediately adjacent blue dot. This result can be achieved by arranging the dots into diagonal rows of colors. For example, there are diagonal rows that each contain a red dot, diagonal rows that each contain a green dot and diagonal rows that each contain a blue dot. Although a diagonal pattern is shown and described, it is to be understood that other patterns may be employed.

The controller 26 selects each pixel address of an image from a matrix of pixel points. The matrix is defined by a plurality of pixel points. Once the pixel address has been selected the controller 26 selects one or more dots to be associated with the pixel. Such an arrangement allows the LCD controller 26 to utilize the same dots for different pixels.

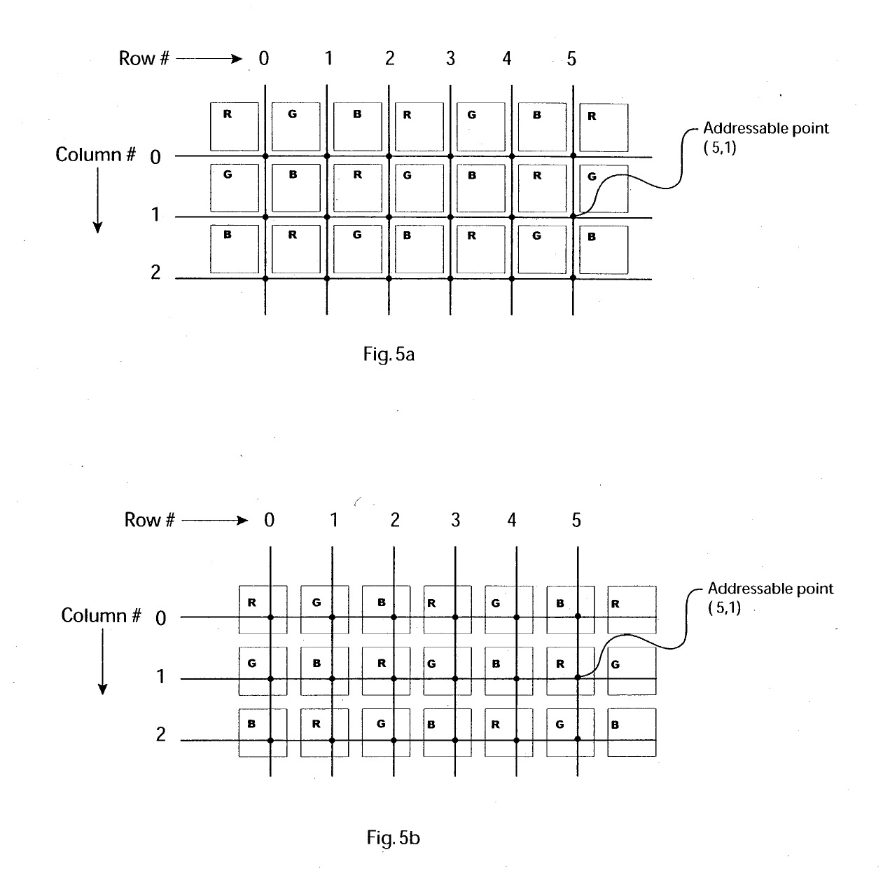

FIG. 5a shows a matrix of pixel points 66 superimposed onto the color filter 58. Each point is associated with a corresponding pixel address. For example, a pixel point may have an address 0,0 that corresponds to the point located at the O row and O column of the matrix. Each pixel point 66 may be located at an intersection between four adjacent dots. Alternatively, the pixel points 66 can be located within a dot of the matrix as shown in FIG. 5b. Although FIGS. 5a and 5b show matrices having pixel points at the intersection of dots, or within the dots, respectively, it is to be understood that other matrices and pixel point locations may be utilized.

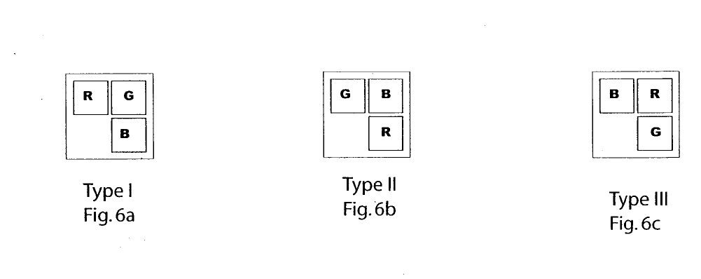

As shown in FIG. 6, given the matrix shown in FIG. 5, the pixels can be categorized into three different pixel types. One pixel type I includes a red dot, a green dot and a blue dot moving in a clockwise direction from the upper left corner. Another pixel type II includes a green dot, a blue dot and a red dot. The third pixel type III includes a blue dot, a red dot and a green dot. The LCD controller 26 can select one of the pixel types and then select one or more of the dots 64 to create a color for each pixel. The pixel type can be determined either with an algorithm or a look-up table, wherein each pixel point and pixel address has an associated pixel type;

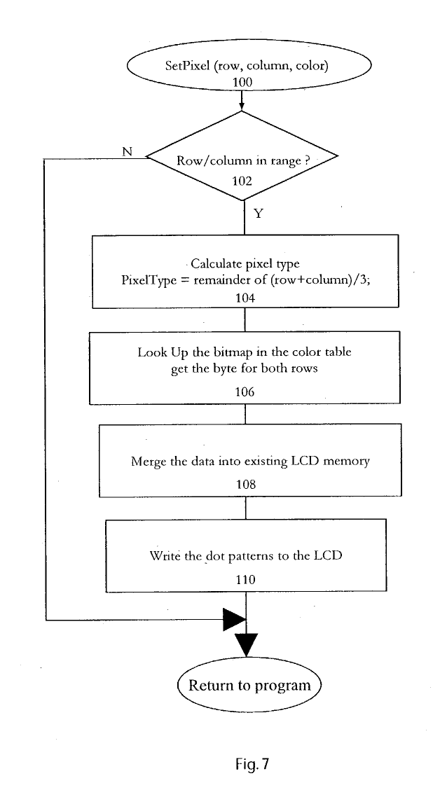

FIG. 7 shows a flowchart regarding an operation of the apparatus to generate an image. In block 100 the microcontroller 30 sends an instruction to set a pixel point to a certain color with address (row and column) and color data. The LCD controller 26 determines whether the column and row specified is outside the given range of the LCD 22 assembled into the apparatus 10, in decision block 102.

In block 104 the controller 26 determines the pixel type given the column and row information. The controller 26 may determine the type from an algorithm wherein the type is equal to the remainder of one-third the sum of the column and row numbers. For example, the pixel address may be column 5, row 1. The remainder would be 0, signifying that the pixel point is a type I pixel.

In block 106 the controller 26 may look up the bitmap for a type I pixel and generate data given the color data and the bitmap information. For example, referring to FIG. 5a, if the color data is red, then the controller 26 will generate instructions and data to “turn on” the red dot located between columns 0 and 1, and rows 4 and 5. This information is stored in memory 28 in block 108 and used to drive the dots and create the color in block 110. This process is repeated for each pixel point. The microcontroller 30 may received input for the pixel data from the touch pad 32, I/O port 34 and/or cartridge 36.

The size of the dots depends on the physical characteristics of the screen 12 and the usage of the apparatus. It is desirable to provide a dot size so that a determinate angle is no less than a deviation angle of the display. The determinate angle being defined as the line from the edge of the display to the eye relative to a line that extends from the eye to a point at the center of the display. The deviation angle is the minimum angle at which the color is correctly perceived by the viewer.

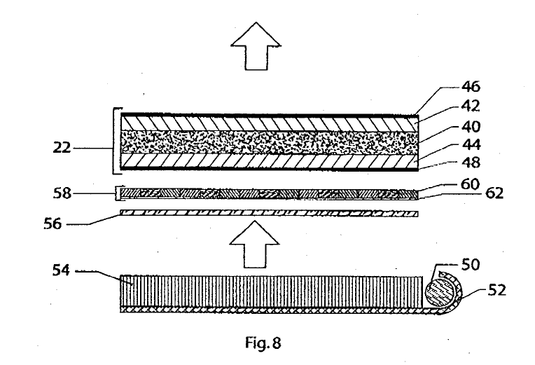

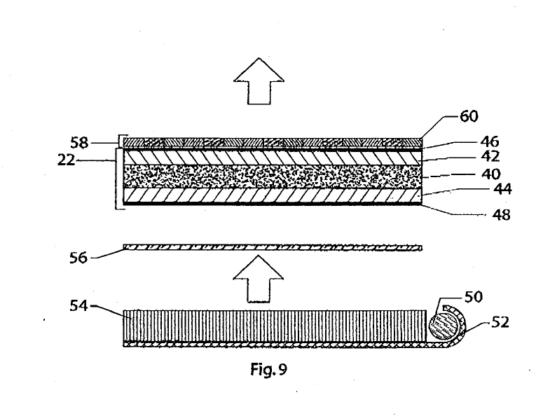

FIGS. 8, 9, 10, 11, 12 and 13 show alternate embodiments of the screen 12. The color filter 58 may be located between the rear polarizer 48 and diffuser 56 as shown in FIG. 8, or attached to the front substrate 42 instead of the rear substrate 44 as shown in FIG. 9.

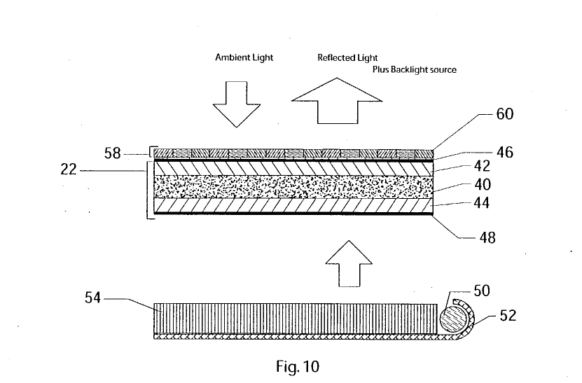

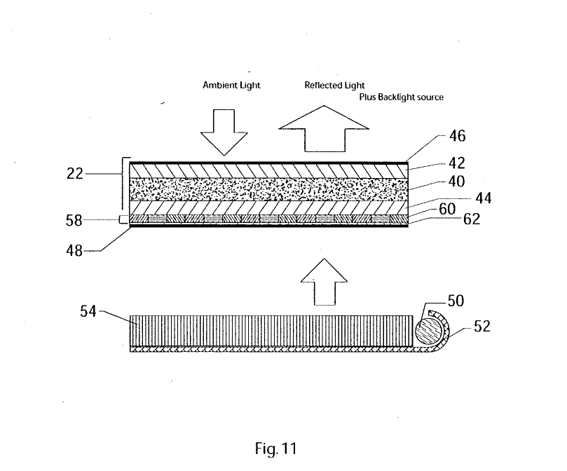

The screen may include a transflective rear polarizer 48′ as shown in FIGS. 10 and 11. The transflective display shown in FIGS. 10 and 11 allows illumination from both the backlight 50 and the ambient.

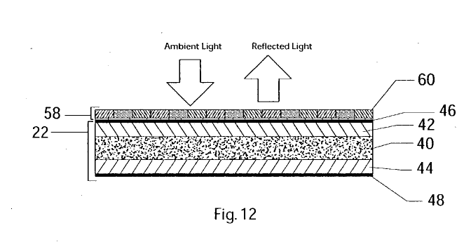

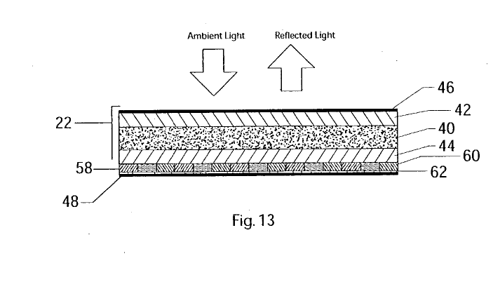

The screen may be constructed without a backlight and with a totally reflective rear polarizer 48″ as shown in FIGS. 12 and 13. In the reflective displays shown in FIGS. 12 and 13 the ambient light is reflected back through the LCD 22 and color filter 58 from the rear polarizer 48″.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An image display apparatus, comprising:
a liquid crystal display that contains a plurality of dots;
a color filter coupled to said liquid crystal display, said color filter creating dots of different colors; and,
a controller that receives a pixel address that corresponds to a pixel point located within a matrix of pixel points associated with said colored dots, selects one of a plurality of dot patterns to correspond to said pixel address, and selects one or more dots within said selected dot pattern.

2. The image display apparatus of claim 1, wherein said color filter includes a first dot having a first color, a second dot having a second color and a third dot having a third color, said dots being arranged to include a diagonal of said first color of dots, a diagonal of said second color of dots and a diagonal of said third color of dots.

3. The image display apparatus of claim 1, wherein said pixel point is located at an intersection between four colored dots.

4. The image display apparatus of claim 1, wherein said pixel point is located within a color dot.

5. The image display apparatus of claim 1, wherein each dot pattern is one of a plurality of pixel types.

6. The image display apparatus of claim 1, wherein each dot pattern includes a blue dot, a green dot and red dot.

7. The image display apparatus of claim 1, wherein said dot pattern is L-shaped.

8. The image display apparatus of claim 1, wherein said dot pattern is selected in accordance with an algorithm.

9. The image display apparatus of claim 1, wherein said color filter is located external to said liquid crystal display.

10. An image display apparatus, comprising:
a liquid crystal display that contains a plurality of dots;
a color filter coupled to said liquid crystal display, said color filter creating dots of different colors; and,
means for receiving a address that corresponds to a pixel point located within a matrix of pixel points associated with said colored dots, selecting one of a plurality of dot patterns to correspond to said pixel address, and selecting one or more dots within said selected dot pattern.

11. The image display apparatus of claim 10, wherein said color filter includes a first dot having a first color, a second dot having a second color and a third dot having a third color, said dots being arranged to include a diagonal of said first color of dots, a diagonal of said second color of dots and a diagonal of said third color of dots.

12. The image display apparatus of claim 10, wherein said pixel point is located at an intersection between four colored dots.

13. The image display apparatus of claim 10, wherein said pixel point is located within a color dot.

14. The image display apparatus of claim 10, wherein each dot pattern is one of a plurality of pixel types.

15. The image display apparatus of claim 10, wherein each dot pattern includes a blue dot, a green dot and red dot.

16. The image display apparatus of claim 10, wherein said dot pattern is L-shaped.

17. The image display apparatus of claim 10, wherein said dot pattern is selected in accordance with an algorithm.

18. The image display apparatus of claim 10, wherein said color filter is located external to said liquid crystal display.

19. A method for displaying an image on an image display apparatus, comprising:
receiving a pixel address associated with a pixel point located within a matrix of pixel points, the matrix of pixel points being associated with a plurality of color dots of a liquid crystal display;
selecting a dot pattern from a plurality of dot patterns to correspond to the pixel address;
selecting one or more dots within the selected pixel pattern; and,
generating a first color from the selected at least one dot.

20. The method of claim 19, wherein the dot pattern is selected in accordance with an algorithm.
